(19) United States
(12) Patent Application Publication
(10) Pub. No.: US 2008/0080993 A1
(43) Pub. Date: Apr. 3, 2008

(54) Hermetic compressor

(75) Inventor: Rio Ryu, Gwangsan-gu (KR)

Correspondence Address: BLANK ROME LLP, 600 NEW HAMPSHIRE AVENUE, N.W., WASHINGTON, DC, 20037, US

(73) Assignee: Samsung Gwangju Electronics Co., Ltd.

(21) Appl. No.: 11/826,768

(22) Filed: Jul. 18, 2007

(30) Foreign Application Priority Data
Oct. 2, 2006 (KR) 10-2006-0096862

(51) Int. Cl. F04B 35/00; F16C 15/00; F16H 21/50

(52) U.S. Cl. 417/415; 74/22 A; 74/570.1; 74/572.2; 92/128; 92/187

(57) ABSTRACT

A hermetic compressor with a connecting rod that can be assembled with a crankshaft and a piston while the piston is in a cylinder integrally formed with a frame. The hermetic compressor includes the frame formed with a hollow portion, a drive unit disposed on the frame, a cylinder integrally formed with the frame, the piston disposed within the cylinder, a crankshaft, and a connecting rod. The piston linearly reciprocates within the cylinder. The crankshaft has a main shaft portion adapted to rotate by a drive force of the drive unit, an eccentric shaft portion provided at one end of the main shaft portion, and a weight balance portion provided between the main shaft portion and the eccentric shaft portion. The main shaft portion is rotatably supported in the hollow portion. The eccentric shaft portion is positioned eccentrically relative to the main shaft portion. The weight portion is adapted to compensate for a rotating imbalance caused by the eccentric shaft portion. The eccentric shaft portion is fabricated separately from the crankshaft and rotatably coupled to the weight balance portion. The connecting rod couples the eccentric shaft portion and the piston. The connecting rod is formed to convert a rotating motion of the crankshaft into the linearly reciprocating motion of the piston.

### CROSS-REFERENCE TO RELATED APPLICATION

This application claims the benefit of Korean Patent Application No. 2006-0096862, filed on Oct. 2, 2006 in the Korean Intellectual Property Office, the disclosure of which is incorporated herein by reference.

### FIELD OF THE INVENTION

The present invention relates to a hermetic compressor, and, more particularly, to a hermetic compressor in which a piston, installed in a cylinder, can be easily assembled to a crankshaft via a connecting rod when the cylinder is integrally formed with a frame.

### BACKGROUND OF THE INVENTION

In general, a hermetic compressor is employed in a refrigeration cycle of a refrigerator or air conditioner. As shown in FIG. 1, a conventional hermetic compressor includes a hermetic casing 1 forming an exterior of the compressor, a compressing unit 2 to perform the compression of a refrigerant within the hermetic casing 1, and a drive unit 3 to provide a compressive drive force required for the compression of the refrigerant.

Both the drive unit 3 and the compressing unit 2 are installed upon a frame 4. The drive unit 3 is installed around a lower portion of the frame 4, and the compressing unit 2 is installed on an upper portion of the frame 4. A cylinder 2b, which defines a compressing chamber 2a therein, is integrally formed at the upper portion of the frame 4, to prevent unintentional separation of the cylinder 2b.

The drive force of the drive unit 3 is transmitted to the compressing unit 2 via a crankshaft 5. The crankshaft 5 is rotatably installed in a central hollow portion 4a of the frame 4 by a main shaft portion 5a thereof that will be described hereinafter.

The crankshaft 5 includes a main shaft portion 5a, an eccentric shaft portion 5c, and a weight balance portion 5b, which are integrally formed with each other. The main shaft portion 5a has an upper portion rotatably supported in the hollow portion 4a of the frame 4 and a lower portion press-fitted in a rotor 3b of the drive unit 3. The eccentric shaft portion 5c is located at the upper portion of the main shaft portion 5a at an eccentric position relative to the main shaft portion 5a. The weight balance portion 5b is provided between the eccentric shaft portion 5c and the main shaft portion 5a. The weight balance portion 5b is adapted to compensate for a rotational imbalance caused by the eccentric shaft portion 5c. A connecting rod 6 is connected between the eccentric shaft portion 5c and a piston 2c of the compressing unit 2 and adapted to convert a rotating motion of the crankshaft 5 into a linearly reciprocating motion of the piston 2c.

When electric current is applied to a stator 3a of the drive unit 3, the rotor 3b is rotated via electromagnetic interaction between the stator 3a and the rotor 3b, thus causing the crankshaft 5, press-fitted into the rotor 3b, to be rotated together with the rotor 3b. Thereby, as the eccentric shaft portion 5c of the crankshaft 5 is eccentrically rotated, the piston 2c, which is connected to the eccentric shaft portion 5c via the connecting rod 6, performs a linearly reciprocating motion in the compressing chamber 2a to compress the refrigerant in the compressing chamber 2a.

The connecting rod 6 is provided, at one end thereof, with a large-diameter portion 6a to be coupled to the eccentric shaft portion 5c and, at another end thereof, with a small-diameter portion 6b to be coupled to the piston 2c. The connecting rod 6 connects the piston 2c, inserted in the compressing chamber 2a, to the eccentric shaft portion 5c. However, since the cylinder 2b is integrally formed with the frame 4 and cannot be separated from the frame 4, assembling the eccentric shaft portion 5c and the piston 2c to the connecting rod 6 is difficult in the conventional hermetic compressor.

To connect the eccentric shaft portion 5c and the piston 2c via the connecting rod 6, first, the piston 2c is coupled to the small-diameter portion 6b by fastening a piston pin 2d, and then the piston pin 2d is fixed by a fixing pin 2e. After inserting the piston 2c into the compressing chamber 2a, the large-diameter portion 6a of the connecting rod 6 is moved aside so that the main shaft portion 5a of the crankshaft 5 can be inserted into the hollow portion 4a of the frame 4. Thereafter, the large-diameter portion 6a of the connecting rod 6 is lifted up so as to be fitted around the eccentric shaft portion 5c. However, since the piston 2c is coupled to the small-diameter portion 6b of the connecting rod 6 and already in the compressing chamber 2a, it is difficult to lift the large-diameter portion 6a over the eccentric shaft portion 5c in order to fit the large-diameter portion 6a around the eccentric shaft portion 5c.

One approach to simplify the coupling of the large-diameter portion 6a and the eccentric shaft portion 5c is to provide the large-diameter portion 6a with an inner diameter slightly larger than an outer diameter of the eccentric shaft portion 5c. By providing the large-diameter portion 6a with a slightly larger inner diameter, a bushing 7 can be installed between the inner periphery of the large-diameter portion 6a and the outer periphery of the eccentric shaft portion 5c after the large-diameter portion 6a is fitted around the eccentric shaft portion 5c. However, this approach increases the number of constituent elements of the hermetic compressor.

### SUMMARY OF THE INVENTION

Accordingly, it is an aspect of the invention to provide a hermetic compressor in which a piston, installed in a cylinder, can be easily assembled to a crankshaft via a connecting rod when the cylinder is integrally formed with a frame and cannot be separated from the frame.

One embodiment of the present invention provides a hermetic compressor. The hermetic compressor includes a frame formed with a hollow portion, a drive unit disposed on the frame, a cylinder integrally formed with the frame, a piston disposed within the cylinder, a crankshaft, and a connecting rod. The piston linearly reciprocates within the cylinder. The crankshaft has a main shaft portion adapted to rotate by a drive force of the drive unit, an eccentric shaft portion provided at one end of the main shaft portion, and a weight balance portion provided between the main shaft portion and the eccentric shaft portion. The main shaft portion is rotatably supported in the hollow portion. The eccentric shaft portion is positioned eccentrically relative to the main shaft portion. The weight portion is adapted to compensate for a rotating imbalance caused by the eccentric shaft portion. The eccentric shaft portion is fabricated separately from the crankshaft and rotatably coupled to the weight balance portion. The connecting rod couples the eccentric shaft portion and the piston. The connecting rod is formed to convert the rotating motion of the crankshaft into the linearly reciprocating motion of the piston.

Another embodiment of the present invention provides a hermetic compressor. The hermetic compressor includes a frame formed with a hollow portion, a drive unit disposed on the frame, a cylinder formed integrally with the frame, a piston disposed within the cylinder to linearly reciprocate within the cylinder, a crankshaft including a main shaft portion adapted to rotate by a drive force of the drive unit and rotatably supported in the hollow portion, an eccentric shaft portion provided at one end of the main shaft portion and positioned eccentrically relative to the main shaft portion, at least one restraint portion protruding radially from an outer surface of an upper portion of the eccentric shaft portion, a weight balance portion provided between the main shaft portion and the eccentric shaft portion, and a connecting rod formed to convert a rotating motion of the crankshaft into the reciprocating linear motion of the piston. The eccentric shaft portion is separately made from the crankshaft and rotatably attaches to the weight balance portion. The weight balance portion is adapted to compensate for a rotating imbalance caused by the eccentric shaft portion and has a coupling recess for coupling one end of the eccentric shaft portion. The connecting rod couples to the eccentric shaft portion and the piston. A large-diameter portion is formed at an end of the connecting rod to enclose an outer periphery of the eccentric shaft portion. A restraint groove is formed in an inner periphery of the large-diameter portion of the connecting rod to receive the at least one restraint portion from an upper surface of the restraint groove.

Yet another embodiment of the present invention provides a coupling structure for a drive unit disposed on a frame and a piston in a cylinder formed integrally with the frame. The coupling structure includes a crankshaft including a main shaft portion adapted to rotate by a drive force of the drive unit, an eccentric shaft portion provided at one end of the main shaft portion and positioned eccentrically relative to the main shaft portion, at least one restraint portion protruding radially from an outer surface of an upper portion of the eccentric shaft portion, a weight balance portion between the main shaft portion and the eccentric shaft portion, and a connecting rod formed to convert a rotating motion of the crankshaft into a linearly reciprocating motion of the piston. The eccentric shaft portion is separately made from the crankshaft and rotatably coupled to the weight balance portion. The weight balance portion is adapted to compensate for a rotating imbalance caused by the eccentric shaft portion and has a coupling recess for coupling one end of the eccentric shaft portion. The connecting rod couples to the eccentric shaft portion and the piston. A large-diameter portion is formed at an end of the connecting rod to enclose an outer periphery of the eccentric shaft portion. A restraint groove is formed at an inner periphery of the large-diameter portion of the connecting rod to receive the at least one restraint portion from an upper surface of the restraint groove.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a sectional view of a conventional hermetic compressor;

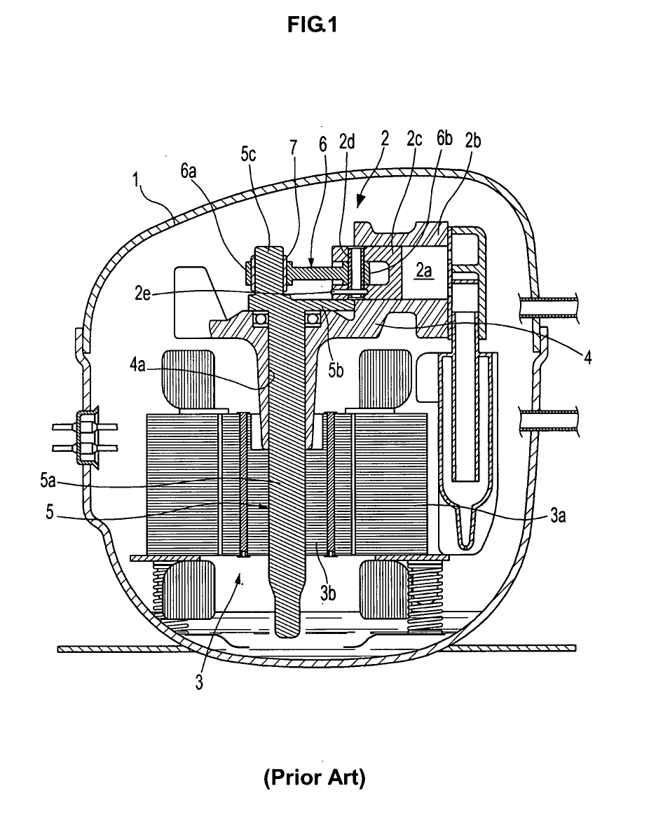

FIG. 2 is a sectional view of a hermetic compressor according to an embodiment of the present invention;

FIG. 3 is an exploded perspective view illustrating a crankshaft, a connecting rod, and a piston of the hermetic compressor according to an embodiment of the present invention;

FIG. 4 is a sectional view of a frame, a main shaft portion, a weight balance portion, and a cylinder of the hermetic compressor according to an embodiment of the present invention illustrating the insertion of the main shaft portion into the frame;

FIG. 5 is a sectional exploded view of the frame, the main shaft portion, the weight balance portion, the cylinder, the connecting rod, and the piston of the hermetic compressor according to an embodiment of the present invention illustrating the insertion of the piston, assembled with the connecting rod, into the cylinder;

FIG. 6 is a sectional exploded view-of the frame, the main shaft portion, the weight balance portion, the cylinder, the connecting rod, the piston, and an eccentric shaft portion of the hermetic compressor according to an embodiment of the present invention illustrating the alignment of the connecting rod and the weight balance portion to receive the eccentric shaft portion; and

FIG. 7 is a sectional view of the frame, the main shaft portion, the weight balance portion, the cylinder, the connecting rod, the piston, and an eccentric shaft portion according to an embodiment of the present invention illustrating the eccentric shaft portion coupled to a coupling recess of the weight balance portion and the connecting rod.

### DETAILED DESCRIPTION OF THE INVENTION

Reference will now be made in detail to a hermetic compressor consistent with an exemplary embodiment of the present invention, examples of which are illustrated in the accompanying drawings, wherein like reference numerals refer to like elements throughout. The embodiment is described below to explain the present invention by referring to the figures.

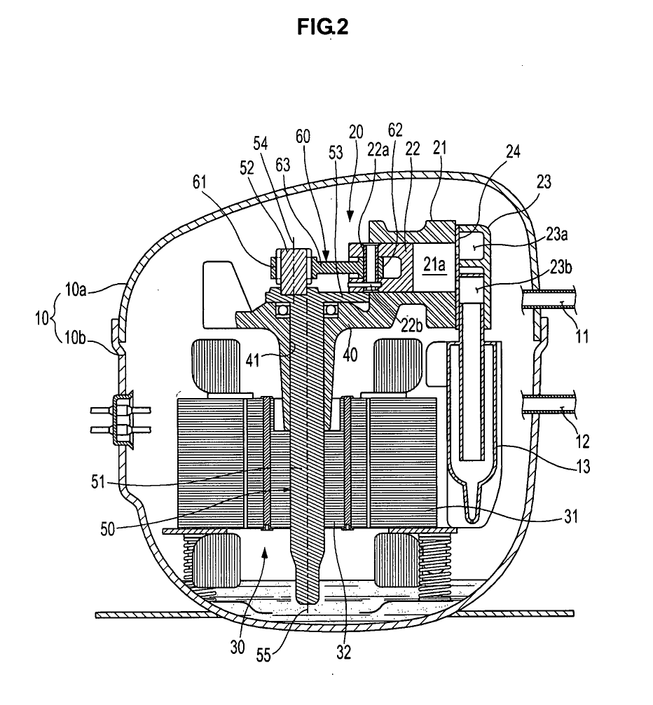

Referring to FIG. 2, the hermetic compressor according to an embodiment of the present invention generally includes a hermetic container 10 formed by coupling an upper container 10a and a lower container 10b to each other. The hermetic container 10 is provided with a suction pipe 11 for guiding a refrigerant from an external station into the hermetic container 10 and with a discharge pipe 12 for guiding the refrigerant, compressed within the hermetic container 10, to the outside of the hermetic container 10.

Provided within the hermetic container 10 are a compressing unit 20 to perform the compression of the refrigerant and a drive unit 30 to provide a drive force required for the compression of the refrigerant. The compressing unit 20 may be disposed on one side of a frame 40, and the drive unit may be disposed on an opposite side of the frame 40. Preferably, the compressing unit 20 is disposed on an upper side of the frame 40, and the drive unit 30 is disposed on a lower side of the frame 40. The frame 40 also preferably has a hollow central portion 41.

The drive unit 30 includes a stator 31 and a rotor 32 provided inside the stator 31. Preferably, the stator 31 is secured around the lower portion of the frame 40. The rotor 32 is adapted to rotate via electromagnetic interaction with the stator 31.

The compressing unit 20 includes a cylinder 21 defining a compressing chamber 21a therein, a piston 22 installed to perform a linearly reciprocating motion in the compressing chamber 21a so as to compress the refrigerant, a cylinder head 23 coupled to an end of the cylinder 21 so as to hermetically seal the compressing chamber 21a, and a valve device 24 provided between the cylinder 21 and the cylinder head 23. The cylinder head 23 has a refrigerant suction chamber 23b and a refrigerant discharge chamber 23a formed therein. The valve device 24 controls the flow of the refrigerant being suctioned from the refrigerant suction chamber 23b into the compressing chamber 21a or being discharged from the compressing chamber 21a into the refrigerant discharge chamber 23a. Preferably, the cylinder 21 is integrally formed with the frame 40 so as not to be separated from the frame 40. The cylinder 21 is also preferably disposed substantially adjacent to an upper side of the central hollow portion 41 of the frame 40.

The refrigerant suction chamber 23b serves to guide the refrigerant, introduced into the hermetic container 10 through the suction pipe 11, into the compressing chamber 21a. The refrigerant discharge chamber 23a is coupled to the discharge pipe 12.

A suction muffler 13 may be disposed within the hermetic container 10. The suction muffler 13 allows the refrigerant, introduced into the hermetic container 10 through the suction pipe 11, to be guided into the refrigerant suction chamber 23b with reduced pressure pulsations.

The drive force of the drive unit 30 is transmitted to the compressing unit 20 via a crankshaft 50. The crankshaft 50 includes a main shaft portion 51, an eccentric shaft portion 52, and a weight balance portion 53. The main shaft portion 51 has a portion rotatably disposed in the central hollow portion 41 of the frame 40 and an opposite portion coupled to the center of the rotor 32. The eccentric shaft portion 52 is preferably provided at an upper side of the main shaft portion 51 at an eccentric position relative to the main shaft portion 51. Preferably, the longitudinal axis 54 of the eccentric shaft portion 51 is not concentric with the longitudinal axis 55 of the main shaft portion 51. The weight balance portion 53 is disposed and adapted to compensate for a rotational imbalance caused by the eccentric rotation of the eccentric shaft portion 52. Preferably, the weight balance portion 53 is provided between the eccentric shaft portion 52 and the main shaft portion 51.

A connecting rod 60 couples the eccentric shaft portion 52 and the piston 22. The connecting rod 60 is adapted to convert a rotating motion of the crankshaft 50 into a linearly reciprocating motion of the piston 22.

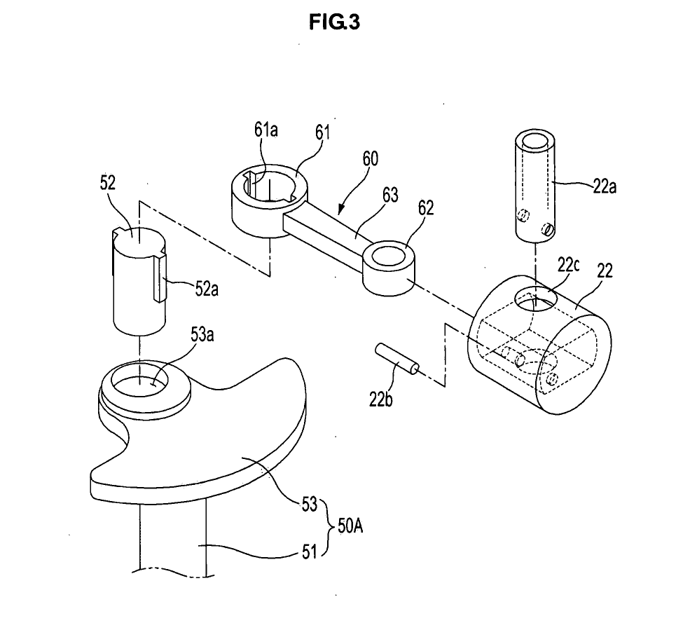

Referring to FIG. 3, the connecting rod 60 has a large-diameter portion 61 provided at one end thereof, a small-diameter portion 62 provided at another end thereof, and a connecting portion 63 provided between the large-diameter portion 61 and the small-diameter portion 62 to integrally connect them. The large-diameter portion 61 is fitted and coupled around an outer periphery of the eccentric shaft portion 52.

Preferably, the piston 22 and the connecting rod 60 are coupled to each other by use of a piston pin 22a. The piston 22 is formed to receive the small-diameter portion 62 of the connecting rod 60, and the small-diameter portion 62 is formed to receive the piston pin 22a. The piston 22 is also formed with holes 22c to receive the piston pin 22a. To couple the small-diameter portion 62 of the connecting rod 60 to the piston 22, the small-diameter portion 62 is inserted into the piston 22 and then the piston pin 22a is inserted into the holes 22c to pin the small-diameter portion 62 within the piston 22. A fixing pin 22b may be fastened in the piston 22 to secure the piston pin 22a at a fixed position.

Thus, when the rotor 32 rotates through electromagnetic interaction with the stator 31, the crankshaft 50 also rotates because it is coupled to the rotor 32. Because the eccentric shaft portion 22 is not concentric with the longitudinal axis 54 of the crankshaft 50, the eccentric shaft portion 22 moves in a path around the longitudinal axis 54 of the crankshaft 50. As the eccentric shaft portion 22 travels along its path, the eccentric shaft portion 22 alternately moves towards the cylinder 21 and away from the cylinder 21. Since the eccentric shaft portion 22 is coupled to the piston 22 via the connecting rod 60, the piston 22 is alternately pushed towards the cylinder 21 and pulled away from the cylinder 21. Thus, the piston 22 performs a linearly reciprocating motion in the compressing chamber 21a. Thereby, when the refrigerant is guided into the hermetic container 10 through the suction pipe 11, the refrigerant is suctioned into the compressing chamber 21a through the refrigerant suction chamber 23b of the cylinder head 23 and compressed in the compressing chamber 21a. After being compressed in the compressing chamber 21a, the refrigerant is discharged to the outside of the hermetic container 10 through the refrigerant discharge chamber 23a of the cylinder head 23 and the discharge pipe 12. Thus, the compressing unit 20 compresses the refrigerant by repeatedly suctioning, compressing, and discharging the refrigerant.

The crankshaft 50 is configured such that the eccentric shaft portion 52 of the crankshaft 50 is assembled with the piston 22 via the connecting rod 60 even though the cylinder 21 is integrally formed with the frame 40 and cannot be separated from the frame 40.

In the embodiment shown, the crankshaft 50 has a body 50A consisting of the weight balance portion 53 and the main shaft portion 51 preferably integrally formed with the weight balance portion 53. The eccentric shaft portion 52 is preferably formed separately from the body 50A. The eccentric shaft portion 52 is formed to couple, at a lower end thereof, to the weight balance portion 53 of the body 50A. Alternatively, the weight balance portion 53 and the main shaft portion 51 may be formed separately from each other and then assembled together.

Preferably, the eccentric shaft portion 52 is formed as a circular cylinder, and the weight balance portion 53 has a circular coupling recess 53a for receiving the lower end of the eccentric shaft portion 52. The circular coupling recess 53a is provided with a predetermined depth as measured relative to an upper surface of a side portion of the weight balance portion 53. To achieve a sufficient depth for the coupling recess 53a, a portion around the coupling recess 53a may have a thicker thickness than another portion of the weight balance portion 53.

Accordingly, a separately provided eccentric shaft portion 52 coupling to the weight balance portion 53 allows the eccentric shaft portion 52 to be assembled with the piston 22 via the connecting rod 60 even though the cylinder 21 is integrally formed with the frame 40 and cannot to be separated from the frame 40.

When the eccentric shaft portion 52 is rotatably coupled to the large-diameter portion 61 and is rotatably inserted in the coupling recess 53a, the eccentric shaft portion 52 may excessively rotate inside the large-diameter portion 61 and the coupling recess 53a. If the eccentric shaft portion 52 rotates excessively, the eccentric shaft 52 may be separated from the coupling recess 53a by vibrations, mechanical agitations, or other similar occurrences caused during the compression of the refrigerant, or may unintentionally slip within the large-diameter portion 61 in the course of compressing the refrigerant. Accordingly, it is preferable to prevent relative rotation between the eccentric shaft portion 52 and the large-diameter portion 61.

To prevent relative rotation between the eccentric shaft portion 52 and the large-diameter portion 61, the eccentric shaft portion 52 preferably has a pair of restraint protrusions 52a protruding radially from an outer surface of an upper portion thereof. Also, the large-diameter portion 61 has restraint grooves 61a formed in an inner periphery thereof. The restraint grooves 61a allow the restraint protrusions 52a to be inserted thereinto from the upper side of the restraint grooves 61a. Since the restraint protrusions 52a are restrained by the restraint grooves 61a, relative rotation between the eccentric shaft portion 52 and the large-diameter portion 61 is prevented. The configuration for preventing the relative rotation of the eccentric shaft portion 52 and the large-diameter portion 61 may be accomplished by other various methods, for example, by press-fitting the eccentric shaft portion 52 to the inner periphery of the large-diameter portion 61.

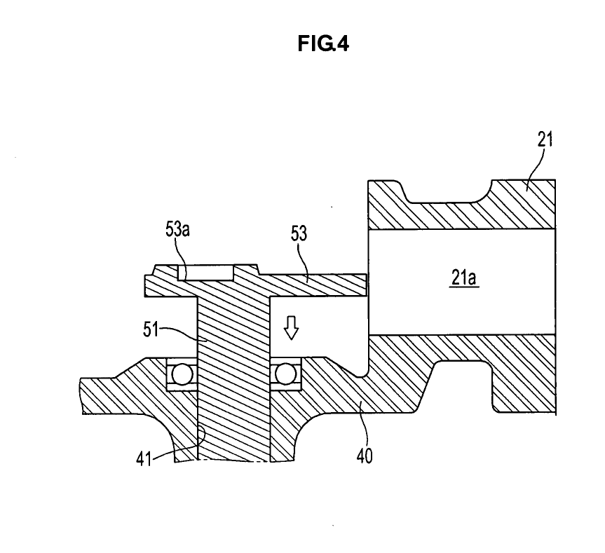

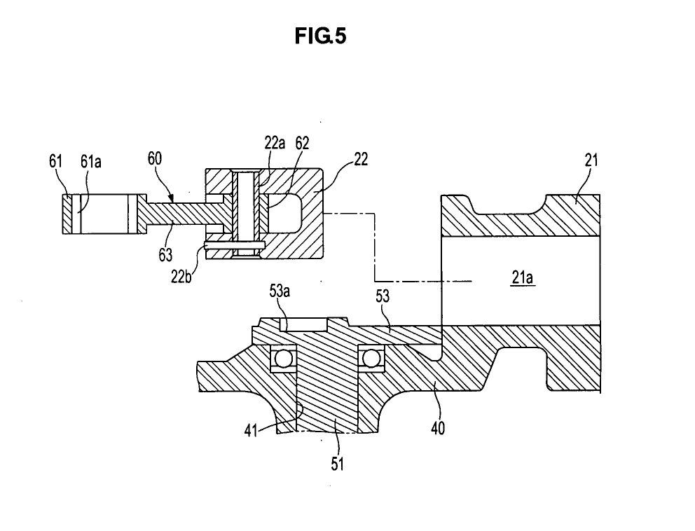

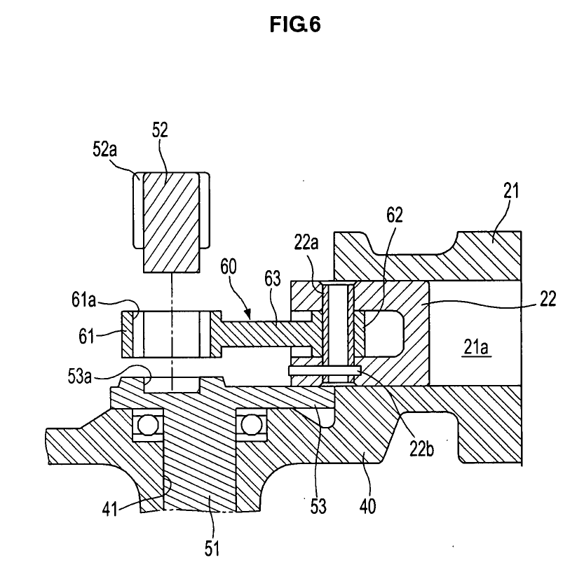

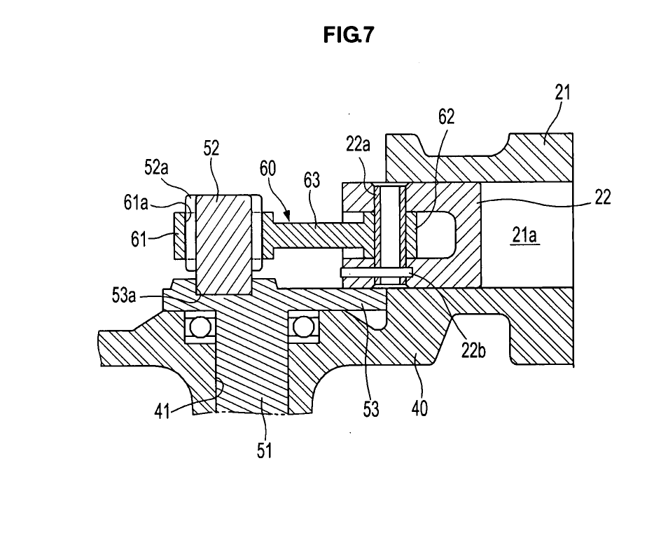

Referring to FIGS. 4 to 7, a sectional view of the main shaft portion 51, the eccentric shaft portion 52, the cylinder 21, the piston 22, the connecting rod 60, and the frame 40 are shown to illustrate the coupling of the piston 22 and the eccentric shaft portion 52 to the connecting rod 60. To couple the eccentric shaft portion 52 to the piston 22 via the connecting rod 60, as shown in FIG. 4, the main shaft portion 51 of the body 50A is first rotatably inserted into the hollow portion 41 of the frame 40. Then, as shown in FIG. 5, before inserting into the cylinder 21, the small-diameter portion 62 of the connecting rod 60 is coupled to the piston 22 by use of the piston pin 22a. The fixing pin 22b is then coupled to secure the piston pin 22a at a fixed position, thus coupling the connecting rod 60 to the piston 22. Thereafter, as shown in FIG. 6, the piston 22 coupled to the connecting rod 60 is inserted into the compressing chamber 21a. Then, the large-diameter portion 61 is positioned over the coupling recess 53a so that it aligns with the coupling recess 53a, and the eccentric shaft portion 52 is inserted from the upper side of the large-diameter portion 61 so that the eccentric shaft portion 52 penetrates through the large-diameter portion 61 and is received in the coupling recess 53a. Thereby, as shown in FIG. 7, the eccentric shaft portion 52 is assembled to the piston 22 via the connecting rod 60.

Accordingly, the eccentric shaft portion 52 can be coupled to the large-diameter portion 61 of the connecting rod 60 without lifting the large-diameter portion 61 of the connecting rod 60 over the eccentric shaft portion 52 when the piston 22, coupled to the small-diameter portion 62, is already in the compressing chamber 21a. Thus, the assembling of the eccentric shaft portion 52 and the piston 22 to the connecting rod 60 is facilitated. Additionally, when the eccentric shaft portion 52 is assembled to the large-diameter portion 61 in the above described manner, the large-diameter portion 61 does not require an inner diameter larger than an outer diameter of the eccentric shaft portion 52, thus a bushing that is normally interposed between the eccentric shaft portion and the large-diameter portion in the conventional hermetic compressor can be omitted. Therefore, the number of constituent elements of the hermetic compressor is reduced.

As described above, the eccentric shaft portion 52 is configured as a separate element and rotatably inserted into the coupling recess 53a. This configuration provides a tolerance between the coupling recess 53a and the eccentric shaft portion 52. The tolerance allows the eccentric shaft portion 52 to be inserted into the coupling recess 53a after the large-diameter portion 61 is aligned with the eccentric shaft portion 52. Thus, the coupling of the eccentric shaft portion 52 to the connecting rod 60 is facilitated.

As apparent from the above description, the present invention provides a hermetic compressor in which an eccentric shaft portion for a crankshaft is separately provided and rotatably coupled to a weight balance portion of the crankshaft. The coupling of the eccentric shaft portion and the weight balance portion is accomplished while assembling the eccentric shaft portion and a piston to a connecting rod. The hermetic compressor consistent with the present invention simplifies the assembling of the piston and the eccentric shaft portion via the connecting rod even when a cylinder is integrally formed with a frame and cannot be separated from the frame.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A hermetic compressor comprising:
a frame formed with a hollow portion;
a drive unit disposed on the frame;
a cylinder formed integrally with the frame;
a piston disposed within the cylinder whereby the piston linearly reciprocates within the cylinder;
a crankshaft including a main shaft portion adapted to rotate by a drive force of the drive unit and rotatably supported in the hollow portion, an eccentric shaft portion provided at one end of the main shaft portion and positioned eccentrically relative to the main shaft portion, and a weight balance portion provided between the main shaft portion and the eccentric shaft portion and adapted to compensate for a rotating imbalance caused by the eccentric shaft portion; and
a connecting rod coupled to the eccentric shaft portion and the piston, the connecting rod formed to convert a rotating motion of the crankshaft into the linearly reciprocating motion of the piston,
wherein the eccentric shaft portion is fabricated separately from the crankshaft and rotatably coupled to the weight balance portion.

2. The hermetic compressor according to claim 1, wherein the weight balance portion has a coupling recess for coupling one end of the eccentric shaft portion.

3. The hermetic compressor according to claim 1, wherein the connecting rod has a large-diameter portion formed to enclose an outer periphery of the eccentric shaft portion.

4. The hermetic compressor according to claim 3, wherein the eccentric shaft portion and the large-diameter portion are configured to prevent a relative rotation therebetween.

5. The hermetic compressor according to claim 1, wherein the eccentric shaft portion has at least one restraint protrusion.

6. The hermetic compressor according to claim 1, wherein the connecting rod has a restraint groove for receiving a protrusion thereby preventing relative rotation between the eccentric shaft portion and the connecting rod.

7. The hermetic compressor according to claim 5, wherein the restraint protrusion protrudes radially from an outer surface of an upper portion of the eccentric shaft portion.

8. The hermetic compressor according to claim 6, wherein the restraint groove is formed in an inner periphery of the connecting rod to receive the protrusion from the upper side of the restraint groove.

9. The hermetic compressor according to claim 3, wherein the eccentric shaft portion is press-fitted to the inner periphery of the large-diameter portion, to substantially restrict a relative rotation between the eccentric shaft portion and the large-diameter portion.

10. The hermetic compressor according to claim 1, wherein the eccentric shaft portion is coupled to the weight balance portion by penetrating through one end of the connecting rod after another end of the connecting rod is coupled to the piston and the piston is disposed within the cylinder.

11. A hermetic compressor comprising:
a frame formed with a hollow portion;
a drive unit disposed on the frame;
a cylinder formed integrally with the frame;
a piston disposed within the cylinder whereby the piston linearly reciprocates within the cylinder;
a crankshaft including a main shaft portion adapted to rotate by a drive force of the drive unit and rotatably supported in the hollow portion;
an eccentric shaft portion provided at one end of the main shaft portion and positioned eccentrically relative to the main shaft portion;
at least one restraint portion protruding radially from an outer surface of an upper portion of the eccentric shaft portion;
a weight balance portion provided between the main shaft portion and the eccentric shaft portion and adapted to compensate for a rotating imbalance caused by the eccentric shaft portion, the weight balance portion having a coupling recess for coupling one end of the eccentric shaft portion;
a connecting rod coupled to the eccentric shaft portion and the piston, the connecting rod formed to convert a rotating motion of the crankshaft into a linearly reciprocating motion of the piston;
a large-diameter portion formed at an end of the connecting rod to enclose an outer periphery of the eccentric shaft portion; and
a restraint groove formed in an inner periphery of the large-diameter portion of the connecting rod to receive the at least one restraint portion from an upper surface of the restraint groove,
wherein the eccentric shaft portion is fabricated separately from the crankshaft and rotatably coupled to the weight balance portion.

12. The hermetic compressor according to claim 11, wherein the eccentric shaft portion is press-fitted to the inner periphery of the large-diameter portion, to substantially restrict a relative rotation between the eccentric shaft portion and the large-diameter portion.

13. A coupling structure for a drive unit disposed on a frame and a piston disposed in a cylinder formed integrally with the frame comprising:
a crankshaft including a main shaft portion adapted to rotate by a drive force of the drive unit;
an eccentric shaft portion provided at one end of the main shaft portion and positioned eccentrically relative to the main shaft portion;
at least one restraint portion protruding radially from an outer surface of an upper portion of the eccentric shaft portion;
a weight balance portion provided between the main shaft portion and the eccentric shaft portion and adapted to compensate for a rotating imbalance caused by the eccentric shaft portion, the weight balance portion having a coupling recess for coupling one end of the eccentric shaft portion;
a connecting rod coupled to the eccentric shaft portion and the piston, the connecting rod formed to convert a rotating motion of the crankshaft into a linearly reciprocating motion of the piston;
a large-diameter portion formed at an end of the connecting rod to enclose an outer periphery of the eccentric shaft portion; and
a restraint groove formed in an inner periphery of the large-diameter portion of the connecting rod to receive the at least one restraint portion from an upper surface of the restraint groove,
wherein the eccentric shaft portion is fabricated separately from the crankshaft and rotatably coupled to the weight balance portion.

14. The coupling structure according to claim 13, wherein the eccentric shaft portion is press-fitted to the inner periphery of the large-diameter portion, to substantially restrict a relative rotation between the eccentric shaft portion and the large-diameter portion.
